(19) United States
(12) Patent Application Publication
(10) Pub. No.: US 2006/0071189 A1
(43) Pub. Date: Apr. 6, 2006

(54) Pressure relief valve

(75) Inventors: James P. Cornwell, Erie, PA (US); Mark Alan Crays, Venango, PA (US)

Correspondence Address: EDWARD W. GOEBEL, JR.;MACDONALD, ILLIG, JONES & BRITTON LLP, 100 STATE STREET, SUITE 700, ERIE, PA, 16507-1498, US

(73) Assignee: R. Conrader Company

(21) Appl. No.: 11/242,550

(22) Filed: Oct. 3, 2005

Related U.S. Application Data
(60) Provisional application No. 60/615,628, filed on Oct. 4, 2004.

(51) Int. Cl. F16K 31/12

(52) U.S. Cl. 251/55

(57) ABSTRACT

A pressure relief valve for exhausting pressure from a pressurized device, includes a valve body that has a first end and a second end, a chamber extending through the valve body, and a valve seat located within the valve body. A valve member comprises a piston and a stem, with the piston shaped so it can be mounted adjacent the valve seat. A spring is mounted within the chamber so as to bias the piston toward the valve seat. In one embodiment a valve cap includes a sidewall shaped to fit around the outside of the second end of the valve body and has a hole through which the stem extends. The valve cap is connected to said valve body in a manner that renders the valve substantially inoperable at the preselected pressure once the valve cap's position is changed. In another embodiment, the stem is a formable wire that extends through the valve body and stem is bent to enable the valve member to move within the valve body.

This application takes priority from U.S. provisional application 60/615,628 filed Oct. 4, 2004, which is incorporated herein by reference.

### BACKGROUND

Pressurized systems normally include pressure relief valves. The purpose of pressure relief valves is to reduce the pressure of a component of a pressurized system when the pressure level within the component is over a preselected level at which the pressure relief valve is set. Safety standards such as those of the Underwriters Laboratories and the Pressure Vessel Code of the American Society of Mechanical Engineers require the use of pressure relief valves for pressure vessels and other components of pressurized systems. For example, these standards require that pressure relief valves discharge pressure from a pressure vessel whenever the pressure in the pressure vessel reaches a selected maximum safe pressure level to avoid an explosion. It is not uncommon for some users for pressurized systems to attempt to alter the maximum rated operating pressure of pressurized systems by attempting to adjust pressure relief valves installed in components of the system. Thus pressure relief valves must be capable of being permanently set to operate at a preselected pressure level. Additionally, these safety standards require that pressure relief valves must be capable of being tested periodically to be sure they haven't been corroded or otherwise damaged so as to inhibit their operation.

Certain pressure relief valves built to comply with these safety standards include a valve body, normally cylindrically shaped, made of a relatively soft metal such as brass, that has a valve chamber extending through it. An inlet end of the valve body can be threaded and sized so that it can be mounted in a pressure vessel such as a pressurized tank or in another pressurized device. A valve seat is normally included within the valve chamber of the valve body. A valve assembly, which includes a piston and an elongated stem manufactured separately or as a single component, is mounted within the valve chamber in a manner that causes the piston to be positioned adjacent the valve seat. An elastomeric seal is usually mounted on the piston so as to contact the valve seat and retain the pressure when the valve is closed. The valve assembly also includes a compression spring mounted within the valve chamber to normally bias the piston and the elastomeric seal toward the valve seat to close the valve.

Many prior art pressure relief valves include a threaded closure of some type which is to be attached to the distal end of the valve body. The closure usually has a hole in it that allows the valve stem to pass through it. The valve body of this type of pressure relief valve has threads formed with respect to it which mate with those on the closure, to retain the closure and thus hold the valve assembly within the valve body. The threads on the closure and valve body allow the closure to be twisted to cause it to move longitudinally with respect to the valve body. This longitudinal movement adjusts the amount of compression of the spring and thus adjusts the force of the spring on the valve piston. The spring force on the valve piston determines the pressure at which the relief valve is opened and thus determines the maximum pressure for a pressurized component, such as a pressure vessel on which the pressure relief valve is mounted. When for a particular valve its manufacturer determines the longitudinal position of the closure that produces the desired spring force, this position must be permanently set to be sure the valve always operates at the required pressure.

Prior art pressure relief valves have employed various types of closures and closure position setting mechanisms to prevent the longitudinal position of closures, and thus the operating pressure of the valves, from being changed once the position has been set at the factory. By way of example, the distal end of the valve body of one type of relief valve has female threads cut within it. These threads mesh with male threads on the outside of an adjustment bolt mounted within the valve body as a closure to hold the compression spring between itself and the valve piston. The adjustment bolt is rotated to change its longitudinal position within the valve body and thus adjust the operating pressure of the valve. The brass valve body adjacent the bolt threads is struck with a tool, such as a punch, when the valve is manufactured. This tool dimples the exterior of the valve body, distorts its internal threads and forces material of the valve body into the threads of the adjustment bolt to hold the adjustment bolt in place. In the past, the longitudinal position of the adjustment bolt of this type of pressure relief valve, and thus the operating pressure of this type of valve, has in the past been altered by the application of a sufficient level of torque to the adjustment bolt to overcome the strength of the material forced into its threads. As a result, operators have been able to change the maximum pressure of pressurized systems in which this type of pressurized relief valve has been used.

Another prior art valve of this type includes a hexagonally shaped hole in a portion of the adjustment bolt. This hole encircles the valve stem and is used to position the adjustment bolt while the valve is being manufactured. The hexagonally shaped hole faces outward from the valve cavity. A hexagonally shaped drive wrench is specially designed to allow the stem shaft to pass through it as it is fitted into the hexagonally shaped hole in the adjustment bolt. Turning the adjustment bolt with the wrench changes the longitudinal position of the adjustment bolt within the valve body and thus changes the force of the compression spring on the valve piston, causing the pressure relief valve to be set to operate at a preselected operating pressure. Once the operating pressure is set, a washer is fitted over the hole in the adjustment bolt and material from the distal end of the valve body is formed over the washer to prevent the washer from being easily removed. However, the brass from the valve body that covers the washer can be filed away and the washer removed. A hole can be formed through a normal hexagonally shaped drive wrench to allow the valve stem to pass through it. This modified drive wrench enables someone to adjust this pressure relief valve. Other types of closures on prior art pressure relief valves have also been adjusted after the valves have been manufactured.

Additionally, if a closure such as a bolt or a cap and the mating portion of the valve body are threaded, these threads must be machined. Machining adds to the complexity and cost of manufacture of valves and should be avoided if possible.

Many pressure relief valves can be tested by pulling on a ring mounted in a hole in the distal end of the valve stem that extends through the closure on the valve body. Pulling the ring causes the valve's stem and piston assembly to move the seal mounted on the piston away from the valve seat. This causes pressure to be released through the valve if the valve is in good condition. If the pressure relief valve sticks, the operator knows it must be replaced.

Rings made for this purpose are normally manufactured from spring steel and look like key rings. That is, the ends of these pull rings overlap one another and are contiguous the body of the rings so as to form a closed loop. It has been found that over time pull rings have been removed from the ends of valve stems on which they've been mounted. Additionally, the closed loops of the rings are pulled apart during installation and ambient conditions such as heat, humidity and chemical vapors have caused the spring steel of these pull rings to deteriorate and lose its temper. The vibration of pressure vessels and other components of pressurized systems for which they've been used have caused them to fall off the ends of the valve stems on which they've been mounted.

### SUMMARY

A pressure relief valve includes a valve body having a first end and a second end and a chamber that extends through the valve body between these ends. The first end of the pressure relief valve is constructed to be mounted in a pressurized device to cause the pressure within that device to be applied to at least a portion of the valve body. The chamber has a valve seat within it. A valve member has an elongated stem and a shape that enables it to be mounted within the chamber adjacent the valve seat. A spring is located within the chamber to force the valve member toward the valve seat to cause the pressure relief valve to normally be closed.

According to one embodiment, a valve cap includes a cap end that contacts the spring to establish a spring force against the valve member and a sidewall shaped to enable it to fit around the outside of the second end of the valve body. The valve cap has a hole in it that allows the valve stem to extend through it. The valve is attached to the valve body at a longitudinal position that compresses the spring sufficiently to achieve a spring force level required to set the pressure at which the pressure relief valve operates. The material and structure of the sidewall and the valve body enable the valve cap to be attached to the valve body in a manner that renders the valve substantially inoperable at the preselected pressure once the position of the valve cap is changed.

According to another embodiment, the valve stem is an elongated piece of formable material that is formed at about its end distal to the valve piston into a shape that enables the valve member to be moved away from the valve seat by pulling the shaped portion of the valve stem away from the valve body.

Those skilled in the art will realize that this invention is capable of embodiments that are different from those shown and that details of the structure of the disclosed pressure relief valve can be changed in various manners without departing from the scope of this invention. Accordingly, the drawings and descriptions are to be regarded as including such equivalent pressure relief valves as do not depart from the spirit and scope of this invention.

### BRIEF DESCRIPTION OF DRAWINGS

For a more complete understanding and appreciation of this invention and many of its advantages, reference will be made to the following Detailed Description taken in conjunction with the accompanying drawings:

FIG. 1A is a perspective view of one end of a pressure relief valve according to one embodiment of this invention;

FIG. 1B is a perspective view of the other end of the pressure relief valve shown in FIG. 1A;

FIG. 2A is a cross-sectional view of the embodiment of a pressure relief valve shown in FIG. 1A;

FIG. 2B is a cross-sectional view of a second embodiment of a pressure relief valve made in accordance with this invention;

FIG. 2C is a third embodiment of a pressure relief valve made in accordance with this invention;

FIG. 3 is an exploded, partial cross-sectional view of the embodiment of the pressure relief valve shown in FIG. 1A;

FIG. 4A is a cross-sectional view of a piston and stem assembly in which the stem is swaged to the piston;

FIG. 4B is an end view of the piston and stem assembly of FIG. 4A;

FIG. 4C is a cross-sectional view of a piston and stem assembly in which a piston crimped onto the stem;

FIG. 4D is a cross-sectional view of a piston and stem assembly in which material from the stem holds the assembly together;

FIG. 4E is a cross-sectional view of a piston and stem assembly held together by an adhesive;

FIG. 5 is a cross-sectional view of a pressure relief valve constructed with a crimped cap in accordance with another embodiment of this invention;

FIG. 6 is a cross-sectional view of a pressure relief valve constructed with a formed stem in accordance with another embodiment of this invention;

FIG. 7A is a cross-sectional view of a pressure relief valve constructed with a crimped cap and a single piece piston and formed stem in accordance with another embodiment of this invention;

FIG. 7B is a cross-sectional view of a pressure relief valve constructed with a single piece piston and formed stem in accordance with another embodiment of this invention;

FIG. 8A is a cross-sectional view of a pressure relief valve constructed with an elongated crimped cap and a formed stem in accordance with another embodiment of this invention;

FIG. 8B is a cross-sectional view of a pressure relief valve constructed with an elongated crimped cap and a single piece piston and formed stem in accordance with another embodiment of this invention;

FIG. 8C is a cross-sectional view of a pressure relief valve constructed with an elongated crimped cap in accordance with another embodiment of this invention;

FIGS. 9A-H are cross-sectional views of embodiments of this invention showing different shapes for the formed stem;

FIG. 10 is a cross-sectional view of a pressure relief valve constructed in accordance with another embodiment of this invention;

FIG. 11 is a cross-sectional view of the steps of assembling a pressure relief valve using the assembly machine shown in FIGS. 12A and 12B;

FIG. 12A depicts one half of an assembly machine used for the automated manufacture of one embodiment of a pressure relief valve;

FIG. 12B depicts the second half of the assembly machine shown in FIG. 1 2A.

### DETAILED DESCRIPTION

Referring to the drawings, similar reference numerals and letters are used to designate the same or corresponding parts throughout the several embodiments and figures. Specific embodiment variations in corresponding parts are noted with the addition of lower case letters next to reference numerals.

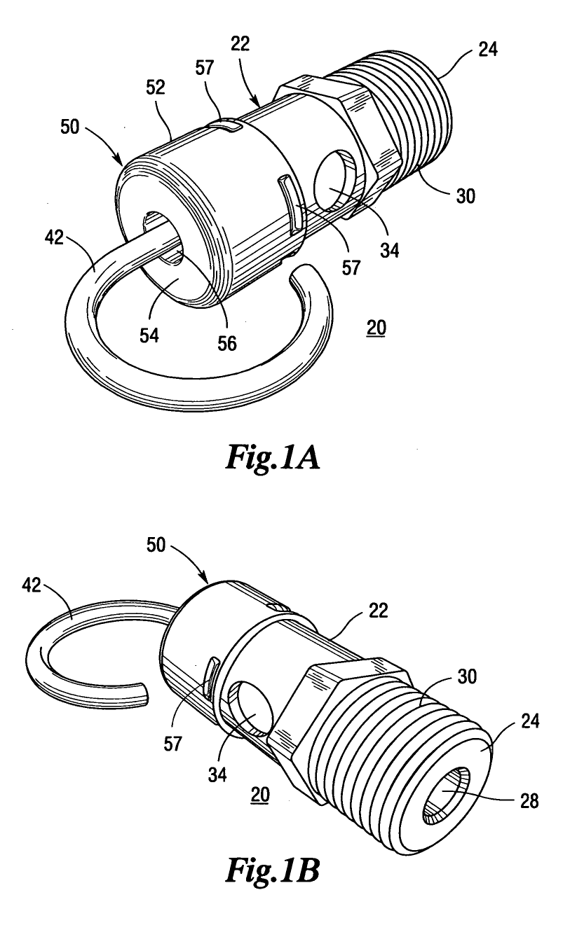

Referring now to FIGS. 1A, 1B, 2A and 3, a pressure relief valve 20 includes an elongated valve body 22 having a first end 24, a second end 26 and a chamber 28 extending between the ends 24 and 26. The first end 24 of the valve body 22 has screw threads 30 machined about its outside diameter so that this end of the valve body 22 can be mounted on a pressurized component, such as a pressure vessel, of a pressurized system. The outside diameter of the threaded first end 24 is sized to fit into holes machined into pressure vessels or other pressurized components. These holes are machined specifically to receive a pressure relief valve of a particular size, such as ¼ inch, ½ inch, ¾ inch, etc. in diameter. As will be more fully explained below, when the pressure relief valve 20 is installed in a component of a pressure system and the system is pressurized, the pressure within the device is applied to a portion of the valve body 22 between the first end 24 and the valve seat 32, which is a part of the valve body 22 located within the chamber 28. The valve seat 32 is a ridge of material, which in the current embodiment faces toward the second end 26 of the valve body 22. The valve body 22 also includes at least one but preferably two or more vent holes 34 evenly spaced around the periphery of the valve body 22 for venting pressure through the valve 20 to atmosphere.

The pressure relief valve 20 includes a valve member 36 having one or more components shaped in a manner that enables the valve member 36 to be mounted within the chamber 28 so that one portion of the valve member 36 is adjacent the valve seat 32. In the embodiment of this invention shown in FIGS. 1A-3, the valve member 36 comprises a piston 38 having a collar 40 at one end into which a valve stem 42 is mounted and having a pocket 44 at the other end in which a disc 46 is mounted.

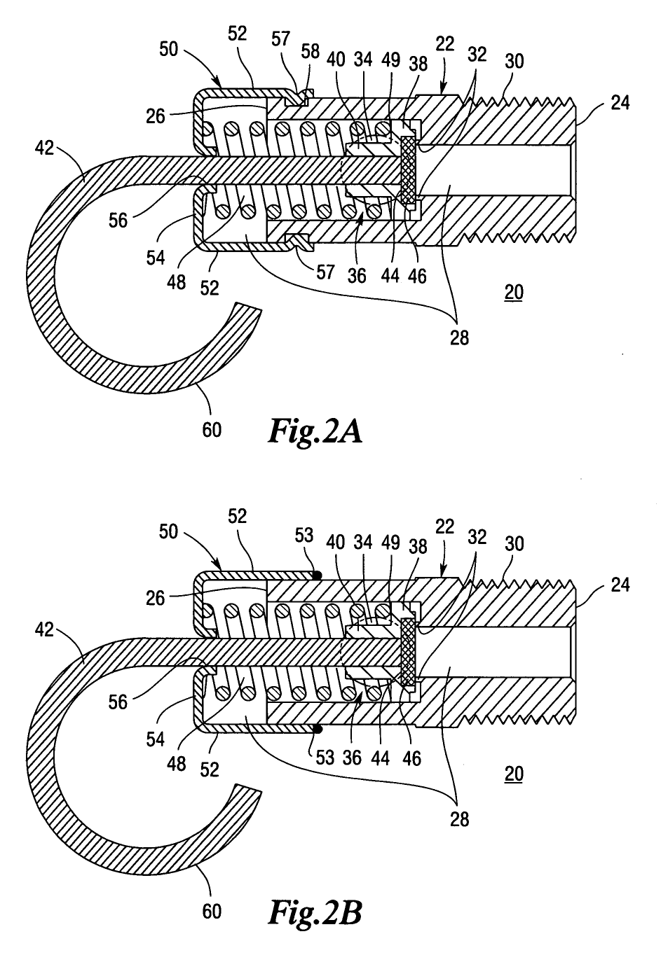

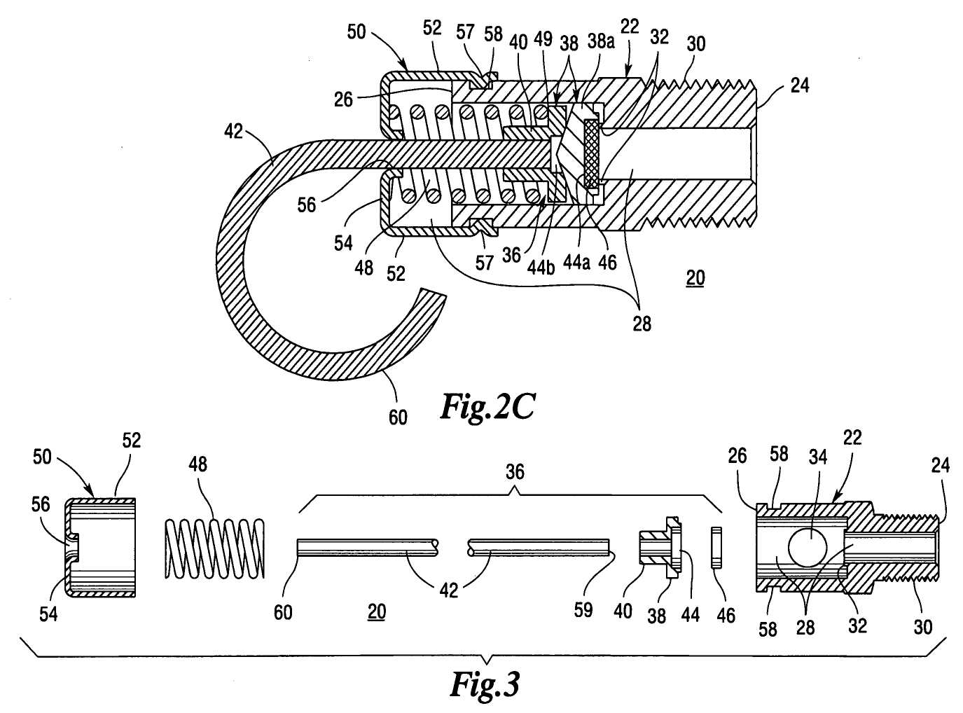

A spring 48 is located within the chamber 28 to bias the valve member 36 toward the valve seat 32 to cause the pressure relief valve to be normally closed. In the embodiment illustrated in FIGS. 1A, 1B, 2A and 3, the spring 48 is a compression spring mounted around a portion of the valve stem 42 that is within the valve chamber 28. The spring 48 extends between a spring seat 49 at the ambient pressure side of the piston 38 and a valve cap 50. The valve cap 50 includes a sidewall 52 having an inside diameter and shape that enables it to slide onto and fit around the outside of the second end 26 of the valve body 22. The valve cap 50 also has an end surface 54 with a hole 56 that allows valve stem 42 to extend through it. The valve cap 50 also withstands some of the pressure of the spring 48 against the valve member 36. A slot 58 has been formed in the valve body 22 to encircle it near the second end 26. A machining process or any other convenient process may form the slot 58. The valve cap 50, including its sidewall 52, and the valve body 22, can be made of a corrosion resistant material such as copper, brass, aluminum, a mild steel, or a plastic material, or any other satisfactory material which enables the sidewall 52 and the valve body 22 to be connected together with a structure and in a manner that renders valve 20 substantially inoperable at the preselected pressure once the position of the valve cap 50 is changed longitudinally on the valve body 22. As shown in FIG. 2A, this is accomplished by having the sidewall 52 crimped into the slot 58 to form indentations 57 at preferably two or more locations around the circumference of the valve body 22 to retain the valve cap 50 on the valve body 22. If a user of the valve attempts to change the axial position of the valve cap 50 on valve body 27, the indentations 57 must be forced out of the slot 58. The size of the indentations changes the shape of the sidewall 52 or possibly the shape of the valve body 22 as the indentations come into contact with the valve body 22. The indentations 57 make it extremely difficult to secure the valve cap 50 at another location on the valve body 22. Additionally, the valve cap 50 would have to be held against the pressure of the spring 48 and the operating pressure determined while an attempt is made to once again secure the valve cap 50 to the valve body 22.

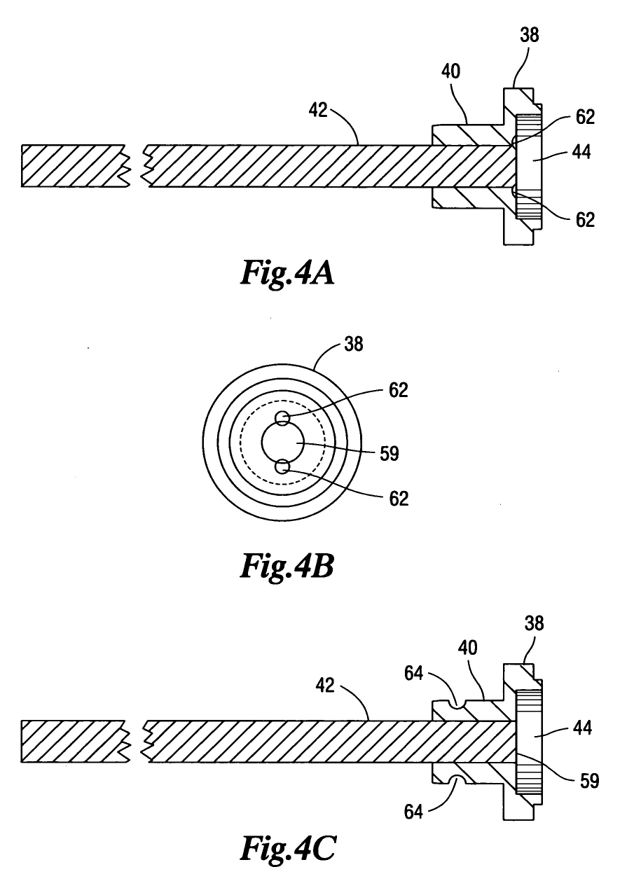

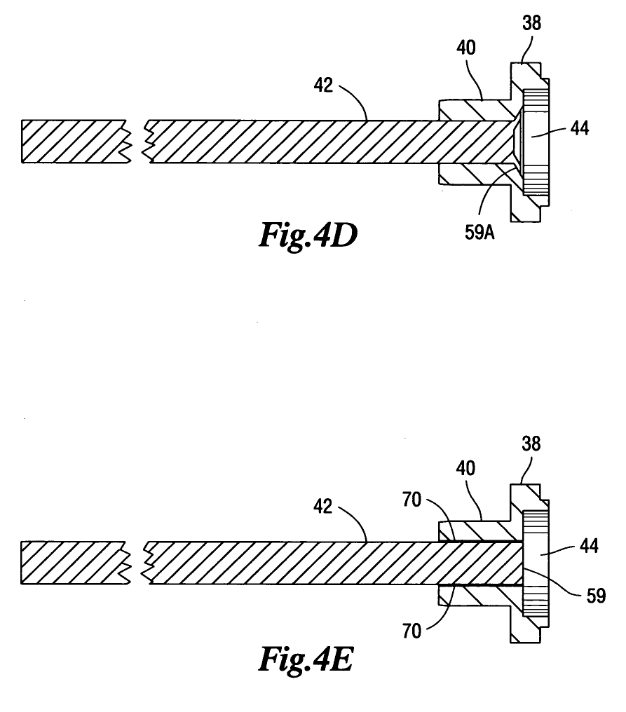

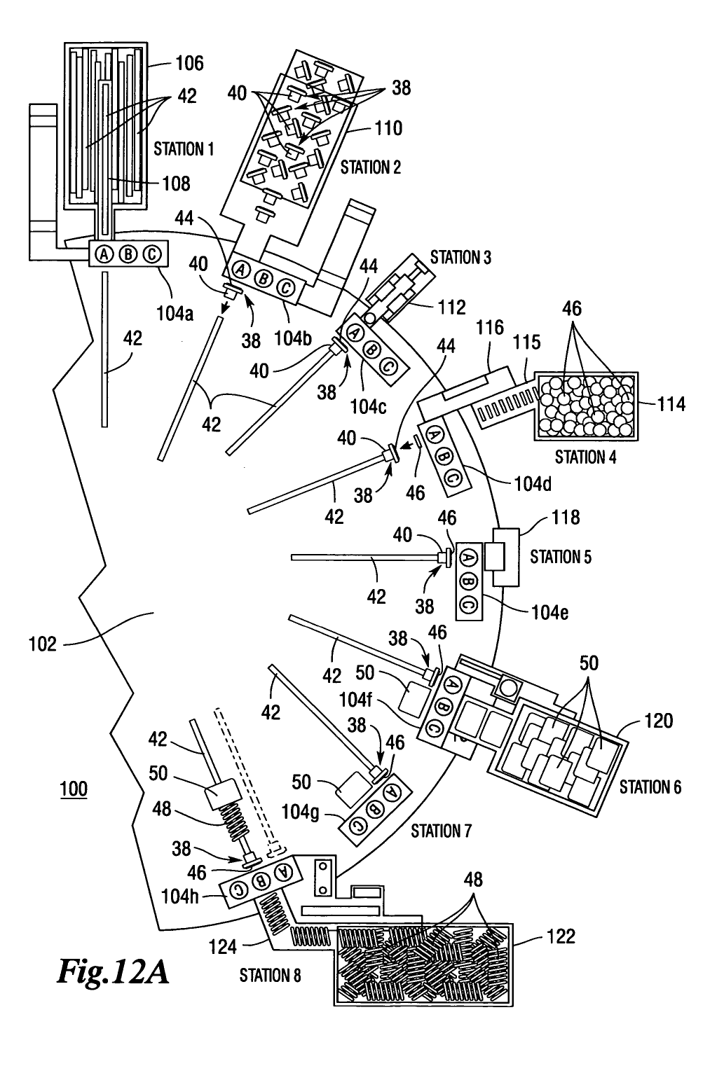

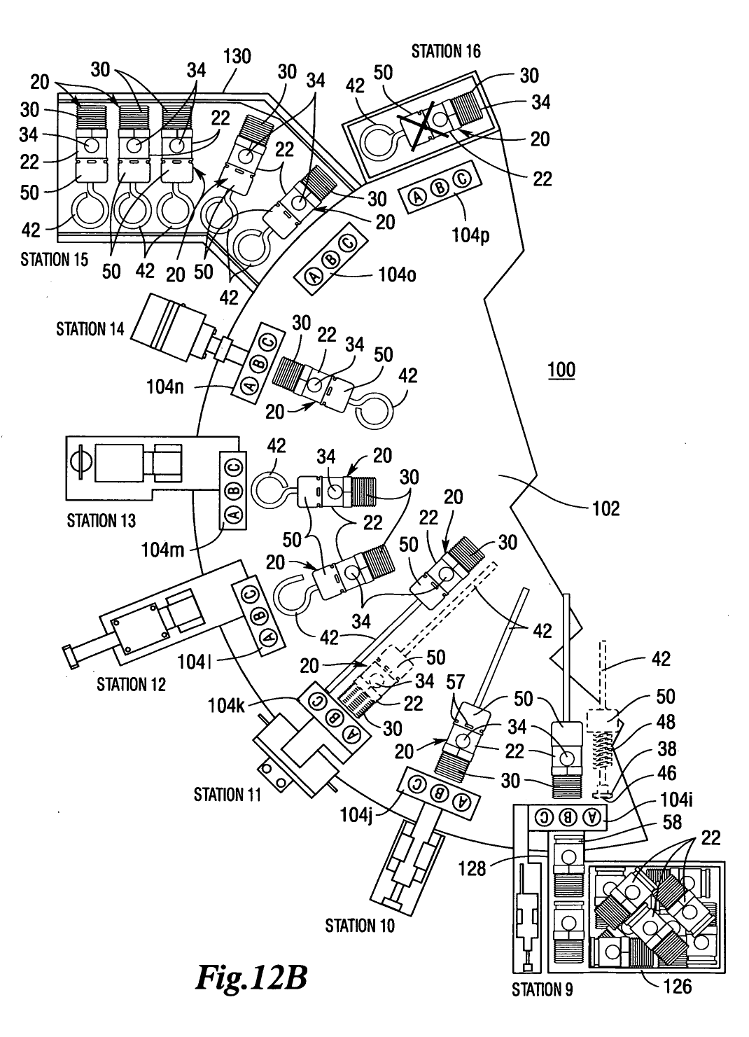

Referring to FIG. 3, the pressure relief valve 20 can be assembled by hand through the use of hand tools or assembly tooling designed to hold the valve 20 and its components during assembly and testing. Alternatively, the pressure relief valve 20 can be assembled using automated assembly machinery as more fully explained below with respect to FIGS. 12A and 12B. Referring again to FIG. 3 by way of brief explanation, the valve member 36 can be assembled by placing one end 59 of the valve stem 42 into the collar 36 so that the end 59 of the valve stem 42 extends to the inside end of the collar 40 or slightly into the pocket 44, depending on the method used to secure the stem 42 to the piston 38. The valve stem 42 is secured to the collar 40 of the piston 38 by one of the methods described below with respect to FIGS. 4A-E or by any other convenient method. The disc 46 can then be placed into the pocket 44, and the compression spring 48 can be placed around the valve stem 42. The valve cap 50 is then added by extending the distal end of valve stem 42 through hole 56 in valve cap 50. The piston 38 and the disc 46 are next placed within the chamber 28 of the valve body 22 and adjacent the valve seat 32. The disc 46 is then in contact with the valve seat 32.

Thereafter, the valve cap 50 is located at a longitudinal position on the valve body 22 that compresses the spring 48 against the piston 38 sufficiently to achieve the spring force level required to set the pressure at which the pressure relief valve 20 is to operate. The sidewall 52 of the valve cap 50 is then crimped into the slot 58 at at least one but preferably two or more positions around the circumference of the valve body 22 to hold the valve cap 50 in place at the selected longitudinal position. Crimping the cap at the selected longitudinal position sets the compression of the spring 48 and the resulting spring force of the spring 48 within the pressure relief valve 20 and thus sets the pressure at which the pressure relief valve 20 operates. Since the valve cap 50 has been crimped, the position of the valve cap 50, and thus the pressure at which the pressure relief valve 20 operates, is difficult to change without damaging the valve cap 50 and preventing it and the pressure relief valve 20 from being used.

The valve stem 42 can be made from a material such as heavy metal wire, which allows its distal end 60 to be bent into a shape that enables the stem 42 to be pulled after pressure relief valve 20 is assembled. Referring to FIG. 2A, when the valve stem 42 is pulled against the force of the spring 48, the piston 38 and the disc 46 are moved away from the valve seat 32 so as to open the pressure relief valve 20. Opening the pressure relief valve 20 allows a pressurized gas such as air to escape through the portion of the chamber 28 that is beneath the screw threads 30, through the gap between the valve seat 32 and the disc 46 and through the vent hole or holes 34 to the atmosphere. Alternatively, the valve stem 42 could be manufactured out of a durable plastic material having one end formed into a circle or into another shape that can be pulled to move the piston 38 and the disc 46 away from the valve seat 32.

Referring now to FIGS. 4A-F, when the piston 38 and the valve stem 42 of the valve member 36 are constructed out of separate components, the valve stem 42 can be attached to the piston 38 through the use of any convenient method. By way of example, FIG. 4A shows the stem 42 swaged to the piston 38. The swaging procedure requires the insertion of the end 59 of the valve stem 42 into the collar 40 of the piston 38 so that the end 59 extends to the end of collar 40 at the inside end of the pocket 44. Both the piston 38 and the valve stem 42 must be held firmly by a vise or a similar tool. A punch or a similar tool is struck by a hammer or other convenient device to make two or more indentations 62 at the juncture of the end 59 of the valve stem 42 and the inside end of the pocket 44 of the piston 38. The placement of indentations 62 is more clearly shown in FIG. 4B. These indentations 62 cause metal from the bottom of the pocket 44 of the piston 38 to join mechanically with metal from the end 59 of the valve stem 42.

FIG. 4C shows the valve stem 42 attached to the collar 40 of the piston 38 through a crimping process. The piston 38 can be manufactured out of a relatively soft metal, such as copper or brass. The valve stem 42 is then placed into the collar 40 of the piston 38. The valve stem 42 and the collar 40 are held together so that the end 59 of the valve stem 42 is about even with the end of the pocket 44. The soft metal of the collar 40 can then be crimped to make one but preferably two or more indentations 64 into the collar 40. The crimping causes the valve stem 42 to be squeezed by the soft metal of the collar 40 beneath the indentations 64 as a result of the force of the crimping process.

In FIG. 4D the valve stem 42 and the piston 48 are shown held together by a process in which an end 59a of the valve stem 42 is installed through the collar 40 so that end 59a extends a short distance into the pocket 44. The end 59a can then be struck with a punch or a die or with another tool that causes the material of the end 59a to be bent over and contact the end of the pocket 44. The end of the pocket 44 can be either tapered as shown in FIG. 4D or it can be flat.

In FIG. 4E, the stem 42 is attached to the collar 40 through the use of an adhesive 70. The adhesive 70 can be applied to the valve stem 42 or to the collar 40, or to both of them, before the valve stem 42 is inserted into the collar 40. The end 59 of the valve stem 42 is then inserted into the collar 40, preferably to about the end of pocket 44, and held firm until the adhesive sets.

The pressure relief valve 20 shown in FIG. 2B is identical to the valve 20 shown in FIG. 2A except that the structure used and the manner of connecting the sidewall 52 of the valve cap 50 to valve body 22 have been changed. The slot 58 has been eliminated. When the material of the sidewall 52 and the material of the valve body 22 is copper, the sidewall 52 and the valve body 22 are connected together by a brazing process depicted by a solder bead 53 shown at the end of the sidewall 52. The solder bead 53 connects the sidewall 52 to the valve body 22 in a manner that renders the valve substantially inoperable at the preselected pressure once the connection is broken and the position of the valve cap 50 is changed since there is nothing to hold the valve cap 50 on the valve body 22 at that time. Thus, the rated operating pressure of the valve 20 cannot be adjusted once the brazed connection is broken without in effect duplicating the manufacturing process of holding the valve cap 50 at some location on the valve body 22 against the pressure of the compression spring 48 and determining the pressure at which the valve will operate, and then brazing a solder bead at the junction of these two copper valve components. This would be a difficult procedure to be undertaken by the operator of pressurized equipment in which the pressure relief valve 20 is installed without the set-up used by the valve manufacturer, making it highly unlikely that the operator would attempt to change the pressure at which the pressure relief valve 20 shown in FIG. 2B is operated.

The actual procedure used to fasten a pressure relief valve 20 of the type shown in FIG. 2B would depend on the material used to make valve cap 50 and valve body 22. As indicated above, a brazing process can be used to produce the solder bead 53 when copper material is used. If mild steel is used for the valve cap 50 and the valve body 22, the valve cap 50 would be welded to the valve body 22, and if a plastic material is used, the sidewall 52 would be sonic welded to the valve body 20.

The pressure relief valve 20 shown in FIG. 2C is identical to the pressure relief valve 20 shown in FIG. 2A, except that the piston 38 includes both the piston structure shown in FIG. 2A and a piston member 38a. The piston member 38a has one side that is conically shaped so as to fit into a pocket 44b, and the piston member 38a has a pocket 44a for holding the disc 46 that contacts the valve seat 32. The purpose of the piston member 38a is to obtain a flexible contact between the disc 46 and the valve seat 32.

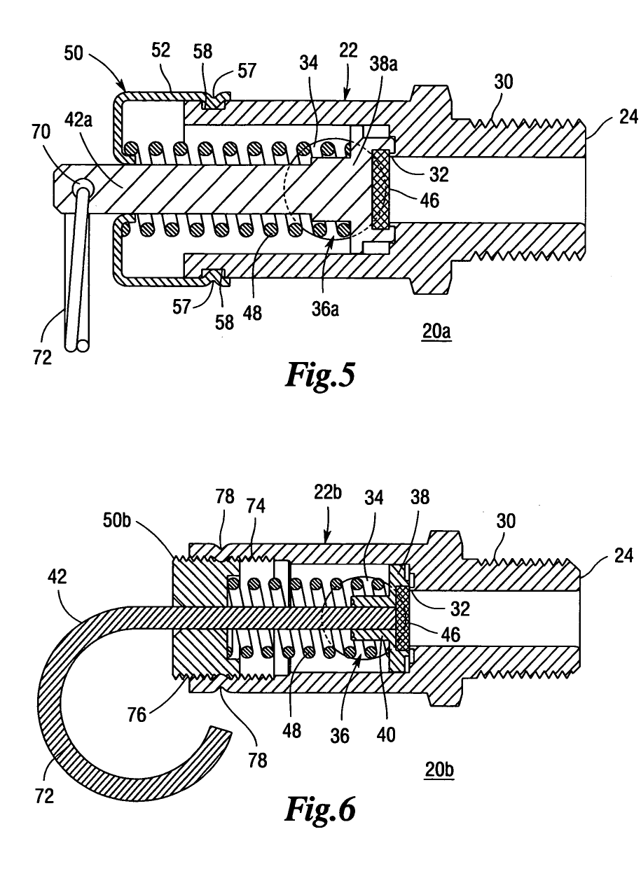

FIG. 5 shows a pressure relief valve 20a that has a valve body 22 and a valve cap 50 that are identical to those shown in FIGS. 1A-3, but it does not have a formable valve stem. The pressure relief valve 20a has a valve member 36a which has its piston member 38a and valve stem 42a manufactured out of a single piece of material. The stem 42a has a hole 70 in its distal end with a ring 72 installed in the hole so it can be pulled to test the pressure relief valve 20a or to relieve pressure from a pressurized component in which the pressure relief valve 20a has been installed.

FIG. 6 shows how a prior art position setting mechanism with a valve stem of an embodiment of the invention. In FIG. 6 a pressure relief valve 20b has a valve member 36, including a formable valve stem 42, that are identical to those shown in FIGS. 1A-3, where it does not have a crimpable cap and valve body slot. The pressure relief valve 20b includes a valve body 22b having a distal end with female threads 74 formed within it. An adjustment bolt 50b has male threads 76 formed around the outside of its circumference so as to mesh with the threads 74 in the valve body 22b. The distal end of valve body 22b includes dimples 78 caused by striking the valve body 22b with a tool such as a punch to the hold the adjustment bolt 50b at a longitudinal position that causes the force of the valve spring 48 to allow the valve to operate at a preselected pressure level.

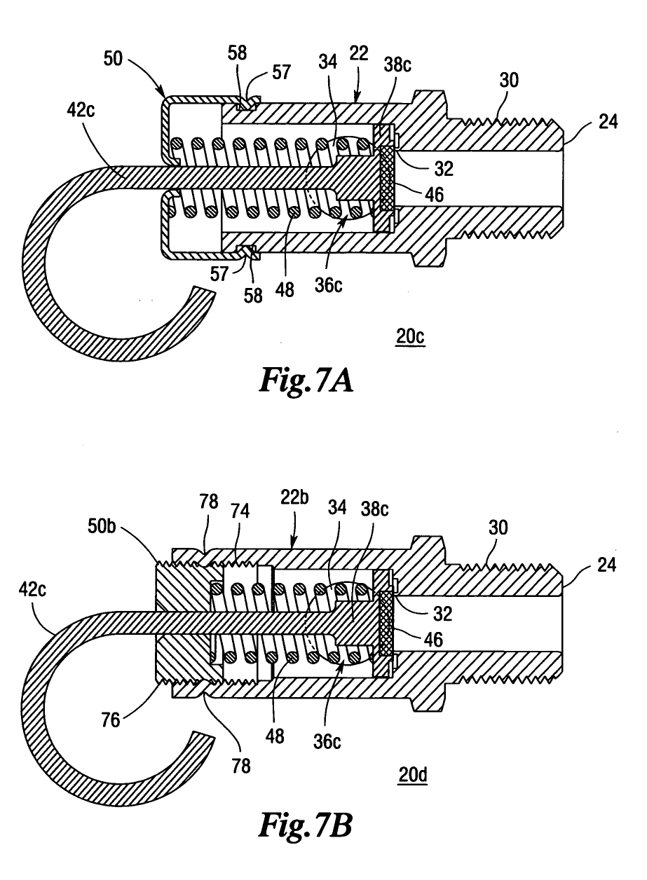

In FIG. 7A the pressure relief valve 20c is constructed in a manner similar to the pressure relief valve shown in FIGS. 1A-3, except that the valve member 36c includes a formable valve stem 42c that is formed as a single component with the piston 38c.

In FIG. 7B a pressure relief valve 20d has an adjustment bolt type closure 50b similar to that shown in FIG. 6, along with a valve member 36c having the single piece formable valve stem 42c and piston 38c.

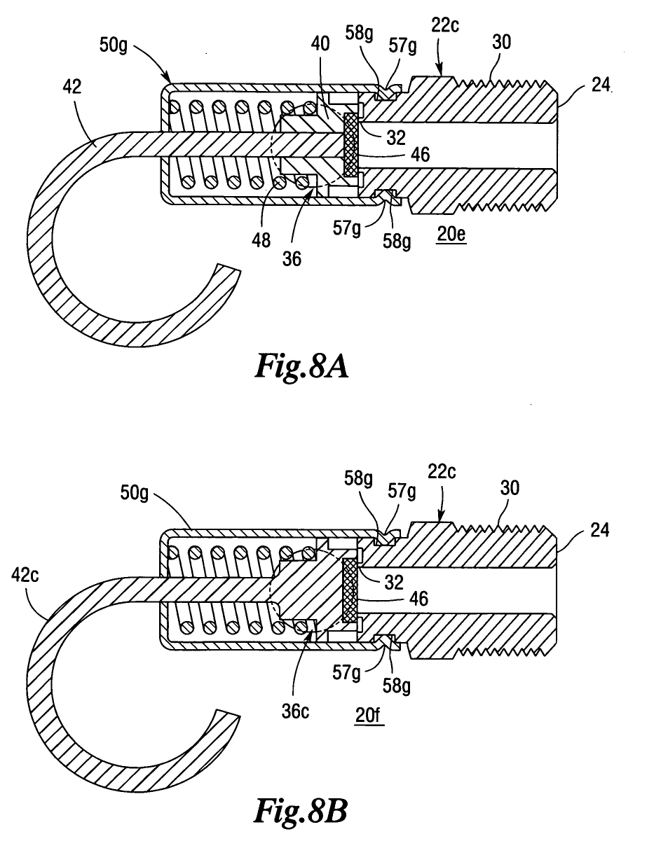

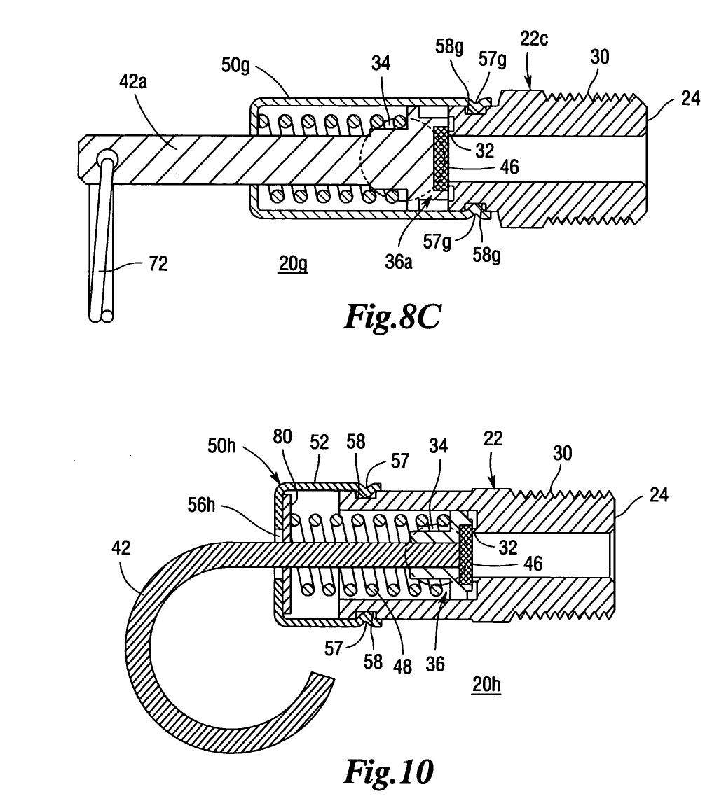

FIGS. 8A-C depict various embodiments of this invention incorporating an elongated valve cap 50g. The valve body 22c has been shortened compared to the valve body 22 shown, for example, in FIG. 2A, and a slot 58g has been appropriately placed near a non-threaded end of the valve body 22c so as to accommodate the elongated valve cap 50g. FIG. 8A depicts a pressure relief valve 20e having an elongated valve cap 50g with a valve member 36 of the type shown in FIG. 2A. FIG. 8B depicts a pressure relief valve 20f that uses an elongated valve cap 50g with a valve stem 42c and a valve member 36c as shown in FIG. 7A. FIG. 8C depicts a pressure relief valve 20g that includes an elongated valve cap 50g with a valve stem 42a having a ring 42 mounted in a hole in its distal end, along with a valve member 36a. Thus, FIGS. 8A-8C show that an elongated valve cap 50g can be used with any type of valve member arrangement that is desired.

In FIG. 10 the pressure relief valve 20h is constructed in a manner similar to the pressure relief valve shown in FIGS. 1A-3, except that the hole 56h in the vent cap 50h is much larger than needed to secure the stem 42, therefore a washer 80 keeps the stem 42 in position and bias the spring 48 against the valve member 36.

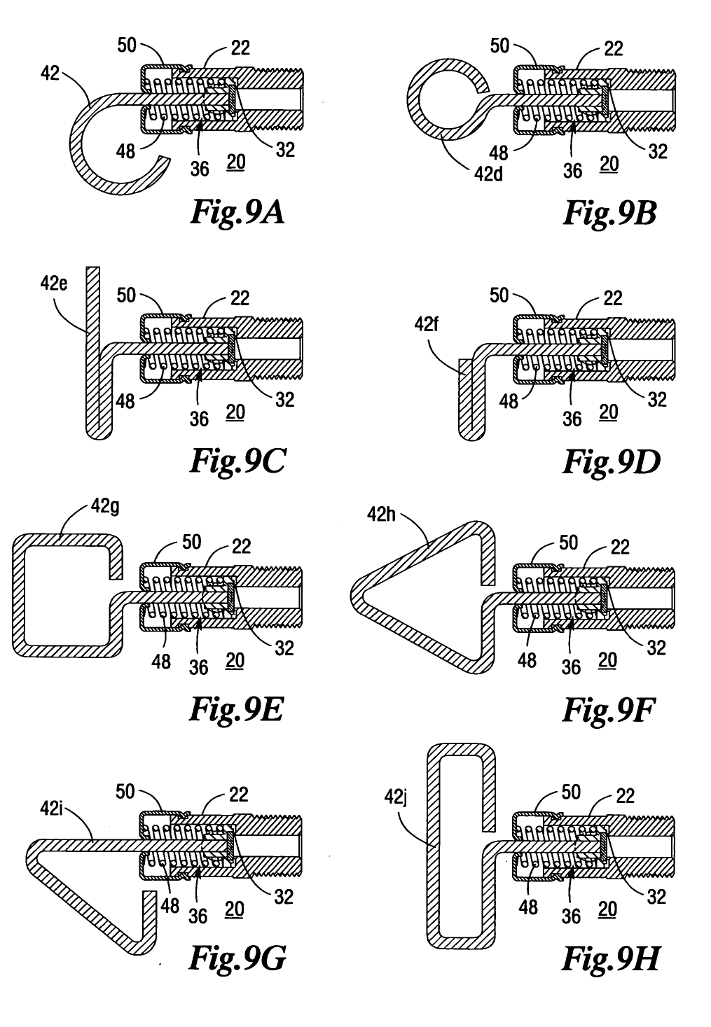

FIGS. 9A-H depict various embodiments of the pressure relief valve 20, each having a valve stem made from an elongated piece of formable material formed into a different shape that enables the valve member 36, or any of its alternate embodiments, to be moved away from the valve seat 32 for testing by an equipment operator. The valve stem 42 could be made into other shapes that accomplish this result, as well.

FIG. 9A shows a valve 20 with a valve stem 42 having its distal end formed into a partially closed circle, FIG. 9B depicts the distal end of a valve stem 42d formed into a substantially closed circle, FIG. 9C includes a valve stem 42e having a T-shaped distal end, FIG. 9D features a valve stem 42f with an L-shaped distal end, FIG. 9E includes a valve stem 42g with a square shaped distal end, FIG. 9F has a valve stem 42h with an equal sided triangular shape, FIG. 9G depicts the distal end of valve stem 42i formed substantially as a right angle triangle, and FIG. 9H depicts a rectangularly shaped distal end of valve stem 42j.

As pointed out above, the pressure relief valve 20, in whatever form it takes, can be assembled by hand or through use of automated assembly equipment. FIGS. 12A and 12B are schematic drawings of one type of automated assembly machine 100, manufactured by Griffin Automation, Inc., of West Seneca, N.Y. 14224, to assemble the valve 20. Assembly machines of this type and the mechanisms used for these machines are well known to those skilled in the art.

The automated assembly machine 100 includes a rotatable, circular indexing table 102 that has 16 locations evenly spaced, with 22.5 degrees between adjacent locations, at which various assembly steps take place. Each of these locations has one of 16 identical holding blocks 104a-p mounted at it. Each of the holding blocks 104a-p is made of an appropriate material, such as steel, and has three nests designated A, B and C formed within it. Nest A is formed to hold the stem 42, both before and the after piston 36 is fastened to it, nest B is formed to hold the valve cap 50 and nest C is formed to retain the assembled pressure relief valve 20 when required for the assembly process.

The automated assembly machine 100 also includes 16 assembly stations, designated Station 1 through Station 16, that are evenly spaced at 22.5 degree intervals around the periphery of the indexing table 102. The automated assembly machine 100 is assembled in such a manner as to locate one of the holding blocks 104a-p adjacent each of the assembly stations 1-16. As shown in FIGS. 12A and 12B, holding block 104a is adjacent Station 1, holding block 104b is adjacent Station 2, holding block 104c is adjacent Station 3, etc.

The automated assembly machine 100 also includes a powered indexing mechanism (not shown) that causes the indexing table 102 to rotate in a clockwise direction and stop its rotation every 22.5 degrees. As a result, each holding block 104a-p is rotated and stopped in sequence at each of the assembly stations 1-16. This allows nests A, B and C of the holding blocks 104a-p to each sequentially receive the components required to assemble the pressure relief valve 20 and allows the components of the pressure relief valve 20 to be subjected to the sequential, automated assembly steps necessary to construct and test the valve 20.

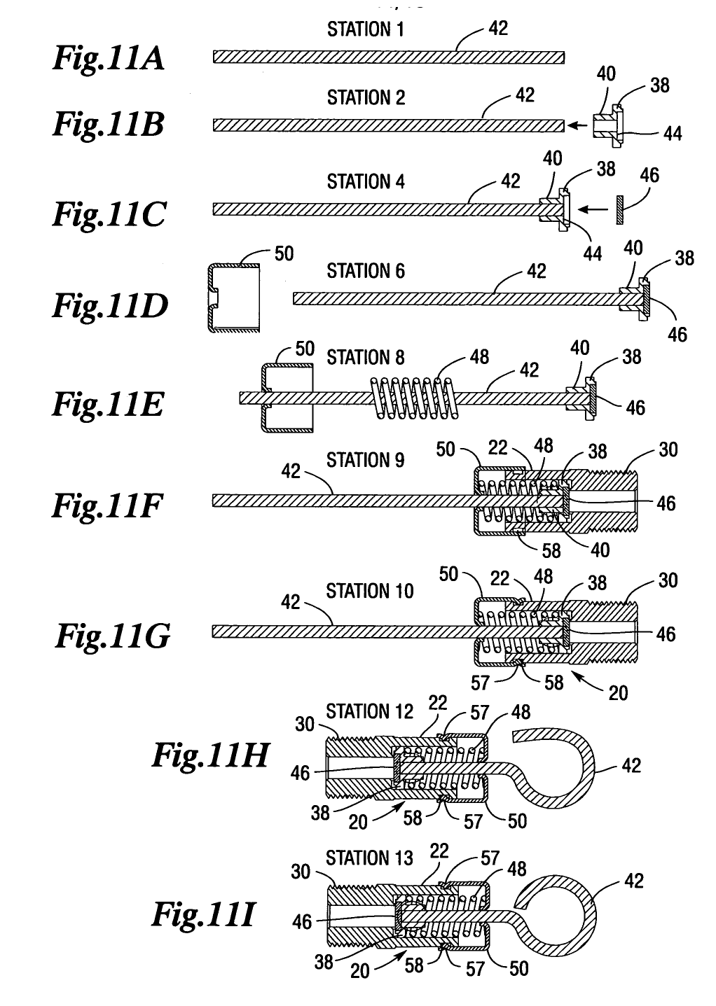

The assembly mechanisms used at each of Stations 1 through 16 are shown schematically in FIGS. 12A and 12B since the mechanisms themselves are well known to those skilled in the art and the details of any particular assembly mechanism are not a part of this invention. The various components used to assemble the pressure relief value 20 are shown within the indexing table 102 and adjacent each holding block 104a-p according to the procedure that occurs at the station at which the holding block is currently located. FIGS. 11A-11I depict in more detail the assembly steps that occur at selected stations.

At Station 1 individual stems 42 that have been cut to the proper length are placed into a vibratory feeder bowl 106 that feeds them one-by-one into a slot in a track 108. The tract 108 is pivotably mounted at Station 1 and has an air cylinder attached to it. After a stem has been fed into the slot in tract 108, the air actuated cylinder, which is not shown, causes the track 108 to pivot about 90 degrees so as to place the stem 42 in nest A of holding block 104a.

At Station 2, pistons 38 are placed into a vibratory feeder bowl 110 where they are fed sequentially toward nest A of the holding block 104b where the stem 42 is located. A set of mechanical gripping fingers, not shown, picks up each piston 38 and places it, collar 40 first, onto the stem 42. A stop member should be located within the gripping fingers that hold piston 38 to prevent the stem from extending into the pocket 44 within the piston 38.

At Station 3, the top of the stem 42 at its junction with the bottom of the pocket 44 of the piston 38 is struck with a punch to cause a material at the end of the stem 42 to be bent over and make contact with and hold the material of the piston 38 at the bottom of the pocket 44. This is accomplished by a pneumatic driving unit 112 shown schematically at Station 3, which has a punch installed at the end of its driver.

At Station 4, a disc 46 is installed within the pocket 44 of the piston 38. Discs 46 are placed in a vibratory feeder bowel 114, which causes the discs to be discharged sequentially through a chute 115. The discs are then picked up and placed within a funneling mechanism 116 that is shown schematically at Station 4. The funneling mechanism 116 compresses each disc to cause it to fit within the pocket 44 of the piston 38 into which it is inserted.

At Station 5, the piston 38 is tested to determine that the assembly step performed at Station 4 was successful and that a disc 46 is, in fact, mounted within the piston 38. Station 5 includes a sensing mechanism 118 that includes a height-sensing probe that determines the height of material within the pocket 44 of the piston 38. If a disc 46 is present within the pocket 44 of the piston 38, the height-sensing probe stops at a known distance. If the height-sensing probe travels farther within the pocket 44, indicating the disc is not present, a set of pneumatically operated gripping fingers at Station 5 remove the combination of the stem 42 and the piston 38 from pocket A of the holding block 104e. If the stem 42 and piston 38 are removed, no further assembly operations are performed with respect to the holding block 104e until it is indexed to Station 1 where it receives another stem 42.

At Station 6 a cap 50 is placed with its open side up into nest B of the holding block 104f. Caps 50 are placed in a vibratory feeder bowl 120 that causes them to be fed one by one toward the holding block 104f. Pneumatically operated fingers (not shown) are used to pick up a cap 50 and drop it into the nest B with the closed part of the cap 50 at the bottom of the nest and the open part facing in an upwardly direction. A light indicator is used to sense the presence of the cap 50 in its proper orientation.

No assembly operations take place at Station 7. However, at Station 8 a spring 48 is dispensed from a vibratory feeder bowl 122 and placed into the open end of the cap 50 located in nest B of the holding lock 104h. Pneumatically controlled fingers are used for the purpose of removing a spring 48 from a chute 124 at the outlet of feeder bowl 122. Thereafter, pneumatic fingers are used to pick the stem 42 and piston 38 from nest A of the holding block 104h and place the distal end of the stem 42 through the center of the spring 48 and through a hole in the middle of the cap 50.

The balance of the assembly and testing of pressure relief valve 20 is shown in FIG. 12B, with the assembly of the valve components also depicted in FIGS. 11F-11I. At Station 9, valve bodies 22 are placed within a vibratory feeding bowl 126 so as to be fed sequentially through a trough 128 at the outlet of the vibratory feeding bowl 126. A valve body 22 is picked up with pneumatically actuated fingers (not shown). The end 26 of the valve body that has a slot 58 formed in it is inserted into the open end of the cap 50 and is pressed to a relatively shallow depth that is sufficient to enable the relative differences between the internal diameter of the cap 50 and external diameter of the inserted end of the valve body 22 to form a pressed fit that causes the valve body 22 to be held within the cap 50.

At Station 10 the pressure relief valve 20 is set to operate at a pressure at which it is to be rated. The valve cap 50 and the valve body 22 are both held by separate mechanisms. Compressed air is applied at the valves rate pressure level to the open end 24 of the pressure relief valve 20. The cap 50 is pushed against the force of the spring 48, causing the spring 48 to compress and its spring force to increase until air stops flowing through the pressure relief valve 20. The sidewalls of the copper cap 20 are then crimped into the slot 58 of the valve body 22, forming indentations 57 so as to hold the cap 50 at this position.

At Station 11, pneumatically operated fingers grip the assembled relief valve 20, remove it from nest B, rotate it 180°, and insert the end 24 having screw threads 30 into nest C.

At Station 12 the initial step is performed in the formation of a loop at the distal end of the stem 42. A circular mandrel is placed at a location on the length of the stem 42 that enables a finger located on the opposite side of the stem 42 to press the stem 42 against the mandrel as the finger rotates around the mandrel. After this step is completed, the end of the stem 42 tends to spring back away from the mandrel so that a full circle is not completed.

Station 13 completes the bending of the end of the stem 42 so as to form a substantially closed circle. Another mandrel is inserted within the partially closed circle formed out of the stem 42. Another finger is used with this mandrel to forcibly bump the distal end of the stem 42 against the mandrel at Station 13. In this manner, the circle at the end of the stem 42 is closed.

At Station 14 a pressure test is conducted on pressure relief valve 20 to ensure it “pops” open to allow airflow at the rated pressure level of the valve 20. If the valve passes the pressure test, it is date stamped at Station 14 and is unloaded from nest C of the holding block 104o at Station 15 through the use of pneumatic gripping fingers and placed onto a conveyor 130 shown at Station 15. If a valve 20 does not pass the pressure test at Station 14, the pneumatic fingers at Station 14 are not operated. Pneumatic fingers at Station 16 remove the failed pressure relief valve 20 from nest C of the holding block 104p, and the rejected valve 20 is placed into a bin to be destroyed. The empty holding block at Station 16 is then indexed to Station 1 to receive another stem 42 in its nest A to begin the assembly process of another pressure relief valve.

This invention has been described with reference to several preferred embodiments. Many modifications and alterations of the pressure valve relief of this invention will occur to others upon reading and understanding the preceding specification. It is intended that this invention be construed to include all such alterations and modifications that come within the scope of the appended claims or the equivalents of these claims.

What is claimed:

1. A pressure relief valve for use to exhaust pressure from a pressurized device, comprising:
a valve body having a first end and a second end and a chamber extending through said valve body between said first end and said second end, said first end mountable on the pressurized device to cause pressure within the pressurized device to be applied to at least a portion of said chamber, a second end having an outside surface and a valve seat located within said valve body;
a valve member comprising a piston and a stem, said piston having a shape which enables said piston to be mounted adjacent said valve seat, a spring mounted within said chamber to bias said piston toward said valve seat;
a valve cap including a sidewall shaped to fit around said outside surface of said second end of said valve body and having a hole therethrough to enable said stem to extend through said valve cap; and
said valve cap connected to said valve body in a manner that renders said pressure relief valve substantially inoperable at the preselected pressure once the position of said valve cap is changed longitudinally on said valve body.

2. A pressure relief valve according to claim 1 further comprising:
the outside surface of said valve body having at least one indentation near said second end of said valve body;
the material of said sidewall enabling said sidewall to be crimped onto said valve body; and
said sidewall crimped into said at least one indentation in at least one location around the periphery of said valve body.

3. A pressure relief valve according to claim 1 further comprising:
the outside surface of said valve body having a slot that forms an indentation encircling said valve body near said second end;
the material of said sidewall enabling said sidewall to be crimped onto said valve body; and
said sidewall crimped into said slot in at least one location around the periphery of said valve body.

4. A pressure relief valve according to claim 1 wherein said sidewall of said valve cap is connected to said valve body by using a brazing process to produce a solder bead at the junction of said sidewall and said valve body.

5. A pressure relief valve according to claim 1 wherein said sidewall of said valve cap is connected to said valve body by welding said sidewall to said valve body.

6. A pressure relief valve according to claim 1 wherein said sidewall of said valve cap is connected to said valve body by sonic welding said sidewall to said valve body.

7. A pressure relief valve according to claim 1 further including a sealing disc mountable on said piston so as to normally contact said valve seat due to the force of said spring.

8. A pressure relief valve according to claim 1 to be mounted on a pressurized device having a hole extending through it with female threads on the surface of the material of the hole, wherein threads are formed on the outside of said first end of said valve body to enable said first end to be mounted on the pressurized device by engagement between said threads on said first end and the female threads on the surface of material surrounding a hole in the pressurized device.

9. A pressure relief valve according to claim 1 wherein:
said stem is initially manufactured separate from said piston;
a first side of said piston having said shape which enables said piston to be mounted adjacent said valve seat and a second side of said piston having an extension shaped to receive one end of said stem, the material of said piston enabling said extension of said piston to be crimped to hold said stem; and
said extension of said piston crimped to said stem with at least one indentation.

10. A pressure relief valve according to claim 1 wherein:
said stem is initially manufactured separate from said piston;
a first side of said piston having said shape which enables said piston to be mounted adjacent said valve seat and a second side of said piston having an extension shaped to receive one end of said stem; and
said stem is swaged to said piston.

11. A pressure relief valve according to claim 1 wherein:
said stem is initially manufactured separate from said piston;
a first side of said piston having said shape which enables said piston to be mounted adjacent said valve seat and a second side of said piston having an extension shaped to receive one end of said stem; and
said stem is secured to said piston by inserting said stem through said second side of said piston until a short portion of said stem extends through said first side of said piston and said short portion of said stem is bent over to contact said first side of said piston.

12. A pressure relief valve according to claim 1 wherein:
said stem is initially manufactured separate from said piston;
a first side of said piston having said shape which enables said piston to be mounted adjacent said valve seat and a second side of said piston having said extension shaped to receive one end of said stem; and
said stem is attached to said piston with adhesives.

13. A pressure relief valve according to claim 1 wherein said stem and said piston are manufactured out of a single piece of material, said stem is bent at about its distal end to enable said valve member to be moved with respect to said valve.

14. A pressure relief valve according to claim 1 wherein said stem comprises a formable wire with its distal end extending outside said valve body, and said stem is bent to enable said valve member to be moved with respect to said valve.

15. A pressure relief valve according to claim 1 wherein said stem has its distal end extending outside said valve body, said stem having a hole along the portion outside said valve body through which a ring is installed to enable said valve member to be moved with respect to said valve.

16. A pressure relief valve according to claim 1 wherein said valve seat is located at about said second end of said valve body.

17. A pressure relief valve according to claim 1 in which said spring is mounted between said piston and said valve cap, and the position of said sidewall of said valve cap on said outside surface of said second end of said valve body determines the pressure at which said pressure relief valve operates.

18. A pressure relief valve for use to exhaust pressure from a pressurized device, comprising:
a valve body having a valve seat;
a valve member comprising a piston and a stem, said piston having a shape which enables said piston to be mounted adjacent said valve seat; and
said stem comprises a formable wire with its distal end extending outside said valve body, and said stem is bent to enable said valve member to be moved with respect to said valve.

19. A pressure relief valve according to claim 18 further including a sealing disc mountable on said piston so as to normally contact said valve seat due to the force of said spring.

20. A pressure relief valve according to claim 18 wherein:
said stem is initially manufactured separate from said piston;
a first side of said piston having said shape which enables said piston to be mounted adjacent said valve seat and a second side of said piston having an extension shaped to receive one end of said stem, the material of said piston enabling said extension of said piston to be crimped to hold said stem; and
said extension of said piston crimped to said stem with at least one indentation.

21. A pressure relief valve according to claim 18 wherein:
said stem is initially manufactured separate from said piston;
a first side of said piston having said shape which enables said piston to be mounted adjacent said valve seat and a second side of said piston having an extension shaped to receive one end of said stem; and
said stem is swaged to said piston.

22. A pressure relief valve according to claim 18 wherein:
said stem is initially manufactured separate from said piston;
a first side of said piston having said shape which enables said piston to be mounted adjacent said valve seat and a second side of said piston having an extension shaped to receive one end of said stem; and
said stem is secured to said piston by inserting said stem through said second side of said piston until a short portion of said stem extends through said first side of said piston and said short portion of said stem is bent over to contact said first side of said piston.

23. A pressure relief valve according to claim 18 wherein:
said stem is initially manufactured separate from said piston;
a first side of said piston having said shape which enables said piston to be mounted adjacent said valve seat and a second side of said piston having an extension shaped to receive one end of said stem; and
said stem is attached to said piston with adhesives.

24. A pressure relief valve according to claim 18 wherein said stem and said piston are manufactured out of a single piece of material.

25. A pressure relief valve for use to exhaust pressure from a pressurized device having a hole extending through it with female threads formed in material surrounding the hole, comprising:
a valve body having a first end and a second end, a chamber extending through said valve body between said first end and said second end and said second end having an outside surface;
said first end having male threads formed therein to enable said pressure relief valve to be mounted on the pressurized device by engagement between said threads on said first end and female threads on the surface of material surrounding a hole in the pressurized device to cause pressure within the pressurized device to be applied to at least a portion of said chamber;
the outside surface of said valve body having a slot formed therein near said second end;
a valve seat located within said valve body;
a valve member comprising a piston and a stem, said stem initially manufactured separate from said piston;
said piston have a first side and a second side, said first side of said piston having a shape which enables said piston to be mounted adjacent said valve seat, said second side of said piston having an extension shaped to receive one end of said stem, said piston further comprising a spring seat and a piston member;
said stem being secured to said piston by inserting said stem through said second side of said piston;
a spring mounted within said chamber to bias said piston toward said valve seat;
said sealing disc mounted on said piston so as to normally contact said valve seat due to the force of said spring on said spring seat of said piston;
a valve cap including a sidewall shaped to fit around the outside of said second end of said valve body and having a hole therethrough to enable said stem to extend through said valve cap, the material of said sidewall enabling said sidewall to be crimped onto said valve body;
said stem comprising a formable wire with a distal end extending through said hole in said valve cap and extending outside said valve body, said stem being bent to enable said valve member to be moved with respect to said valve; and
said sidewall crimped in at least one location in said slot.

26. The method of manufacturing a pressure relief valve for use to exhaust pressure from a pressurized device, comprising:
selecting a valve member comprising a valve stem and a piston, the piston further comprising a spring seat and a piston member;
selecting a compression spring to compress against the spring seat of said piston;
sliding the compression spring over the stem to contact the compression spring with the spring seat of the piston;
selecting a valve cap including a sidewall, the valve cap having a hole therethrough to enable the stem to extend through the valve cap,;
sliding the valve cap over the stem such that the stem extends through the hole in the valve cap and the sidewall extends over the compression spring;
selecting a valve body having a first end and a second end and a chamber extending through the valve body between the first end and the second end, the valve body further comprising a valve seat located within the valve body, the valve body having dimension that will allow the sidewalls of the valve cap to fit around the outside of the second end of the valve body;
positioning the first end of the piston against the valve seat and further sliding the valve cap over the second end of the valve body so that the sidewalls of the valve cap extend over a portion of the outside of the valve body and the compression spring is compressed between the valve cap and the spring seat; and
connecting the valve cap to the valve body in a manner that renders the pressure relief valve substantially inoperable at the preselected pressure if the position of the valve cap is changed longitudinally on the valve body.

27. The method of claim 26 performed using hand tools.

28. The method of claim 26 performed using automated assembly machinery.

29. The method of claim 26 wherein the stem is initially manufactured separate from the piston further comprising:
selecting a valve stem that is a rod of appropriate length having a first end and a second end;
selecting a piston having a first side shaped to enable said piston to be mounted adjacent a valve seat and a second side having an extension shaped to receive one end of the stem; and
securing the stem to the piston by inserting the stem through the piston until a short portion of the first end of the stem extends through the first side of the piston and using a punch or a die to bend the short portion of the first end of the stem over to contact the first side of the piston.

30. The method of claim 26 wherein the stem is initially manufactured separate from the piston further comprising:
selecting a valve stem that is a rod of appropriate length having a first end and a second end;
selecting a piston having a first side shaped to enable said piston to be mounted adjacent a valve seat and a second side having an extension shaped to receive one end of the stem, the material of the piston enabling the extension of the piston to be crimped to hold said stem; and
securing said stem to the piston by inserting the stem through the piston and crimping the extension of the piston to the stem with at least one indentation.

31. The method of claim 26 wherein the stem is initially manufactured separate from the piston further comprising:
selecting a valve stem that is a rod of appropriate length having a first end and a second end;
selecting a piston having a first side shaped to enable the piston to be mounted adjacent a valve seat and a second side having an extension shaped to receive one end of the stem; and
securing the stem to the piston by inserting the stem through the piston and swaging the stem to the piston.

32. The method of claim 26 wherein the stem is initially manufactured separate from the piston further comprising:
selecting a valve stem that is a rod of appropriate length having a first end and a second end;
selecting a piston having a first side shaped to enable said piston to be mounted adjacent a valve seat and a second side having an extension shaped to receive one end of the stem; and
securing the stem to the piston by inserting the stem through the piston and attaching the stem to the piston with adhesives.

33. The method of claim 26 wherein the stem and the piston are manufactured out of a single piece of material.

34. The method of claim 26 further comprising:
selecting a sealing disc mountable on the piston member so as to normally contact the valve seat; and
mounting the sealing disc on the piston.

35. The method of claim 26 wherein the outside surface of the valve body has at least one indentation near the second end of the valve body, and the material of the sidewall of the valve cap enables the sidewall to be crimped onto the valve body, further comprising:
connecting the valve cap to the valve body by crimping said sidewall into at least one indentation in at least one location around the periphery of the valve body.

36. The method of claim 26 wherein the outside surface of the valve body having a slot that forms an indentation encircling the valve body near the second end of the valve body, and the material of the sidewall of the valve cap enables the sidewall to be crimped onto the valve body, further comprising:
connecting the valve cap to the valve body by crimping the sidewall into the slot in at least one location around the periphery of the valve body.

37. The method of claim 26 further comprising connecting the sidewall of the valve cap to the valve body by using a brazing process to produce a solder bead at the junction of the sidewall and the valve body.

38. The method of claim 26 further comprising connecting the sidewall of the valve cap to the valve body by welding the sidewall to the valve body.

39. The method of claim 26 further comprising connecting the sidewall of the valve cap to the valve body by sonic welding the sidewall to the valve body.

40. The method of claim 26 wherein the stem has its distal end extending outside the valve body, the stem having a hole along the portion outside the valve body, further comprising:
installing a ring in the hole to enable the valve member to be moved with respect to the valve.

41. The method of claim 26 wherein the stem comprises a formable wire with its distal end extending outside the valve body, further comprising:
bending the stem to enable the valve member to be moved with respect to the valve.
